(19) United States
(12) Patent Application Publication
(10) Pub. No.: US 2015/0026608 A1
(43) Pub. Date: Jan. 22, 2015

(54) Systems and Methods for Application Management on Mobile Devices

(71) Applicant: Marvell World Trade Ltd., St. Michael (BB)

(72) Inventors: Xi Wu, Shanghai (CN); Jialin Chen, Shanghai (CN); Wenzhao Fang, Shanghai (CN); Ping Shen, Shanghai (CN); Sean Chen, Shanghai (CN)

(21) Appl. No.: 14/333,057

(22) Filed: Jul. 16, 2014

Related U.S. Application Data
(60) Provisional application No. 61/847,190, filed on Jul. 17, 2013.

(51) Int. Cl. G06F 3/0481; G06F 3/0484

(52) U.S. Cl. CPC G06F 3/04817; G06F 3/0484
USPC 715/762

(57) ABSTRACT

Systems and methods are provided for application management on mobile devices. One or more application programming interfaces (APIs) on a mobile device are called in response to a triggering event. A hidden application interface is displayed. A user selection of one or more applications is received on the hidden application interface. The applications (e.g., icons of the applications) are prevented from being displayed on one or more user interfaces of the mobile device.

### CROSS-REFERENCE TO RELATED APPLICATIONS

This disclosure claims priority to and benefit from U.S. Provisional Patent Application No. 61/847,190, filed on Jul. 17, 2013, the entirety of which is incorporated herein by reference.

### FIELD

The technology described in this patent document relates generally to mobile devices, and more particularly to application management for mobile devices.

### BACKGROUND

Application software (apps) often includes software programs designed to carry out operations for one or more specific applications. Apps for mobile devices (mobile apps) are widely used for general productivity, information retrieval or entertainment. For example, a smart phone may include various apps, such as email, calendar, contacts, stock market, weather information, mobile games, GPS and location-based services, banking, order-tracking, ticket purchases and medical apps.

Mobile apps are usually available through application distribution platforms, such as Apple App Store, Google Play, Windows Phone Store, and BlackBerry App World. Mobile apps are often downloaded from the platforms to a target mobile device, such as an iPhone, BlackBerry. Android phone or Windows Phone. Oftentimes, mobile apps are loaded through a user selection of an icon shown on a display interface of a mobile device. The icons and the mobile apps themselves can be organized into folders, and the organization can be visualized on one or more user interfaces. The organization of the mobile apps and the associated icons may involve moving, grouping, deleting, adding, etc.

### SUMMARY

In accordance with the teachings described herein, systems and methods are provided for application management on mobile devices. One or more application programming interfaces (APIs) on a mobile device are called in response to a triggering event. A hidden application interface is displayed. A user selection of one or more applications is received on the hidden application interface. The applications are prevented from being displayed on one or more user interfaces of the mobile device.

In one embodiment, a system is provided for application management on mobile devices. The system includes: one or more processors and a computer-readable storage medium. The processors are configured to: in response to a triggering event, call one or more application programming interfaces (APIs) on a mobile device; display a hidden application interface; receive a user selection of one or more first applications on the hidden application interface; and prevent the first applications from being displayed on one or more user interfaces of the mobile device. The computer-readable storage medium is configured to store information related to the first applications.

In another embodiment, a non-transitory machine-readable storage medium includes programming instructions for application management on mobile devices. The programming instructions are configured to cause one or more data processors to execute certain operations. One or more application programming interfaces (APIs) on a mobile device are called in response to a triggering event. A hidden application interface is displayed. A user selection of one or more applications is received on the hidden application interface. The applications are prevented from being displayed on one or more user interfaces of the mobile device.

### BRIEF DESCRIPTION OF THE DRAWINGS

FIG. 1 depicts an example diagram showing certain applications being hidden from a user interface of a mobile device.

FIG. 2 depicts an example diagram showing a system for hiding certain applications on a mobile device.

FIG. 3 depicts another example diagram showing a system for hiding certain applications on a mobile device.

FIG. 4 depicts an example flow chart for application management on mobile devices.

### DETAILED DESCRIPTION

Sometimes, a user may want to hide some mobile applications (mobile apps) in a mobile device (e.g., a smart phone) so that others cannot see these apps. One approach is to hide the icons associated with these mobile apps from a launcher interface that corresponds to a user interface where a user may customize a home screen of the mobile device, launch mobile apps, make phone calls, and/or perform other tasks. However, the mobile apps may still be found on other user interfaces. For example, the mobile apps can be easily found on a settings interface (e.g., “System Settings”→“Application Management”). Another approach is to disable the mobile apps on the mobile device. However, it may not prevent the mobile apps from showing up on other user interfaces, such as the settings interface. Uninstalling the mobile apps from the mobile device causes inconvenience, and may not be an acceptable solution either.

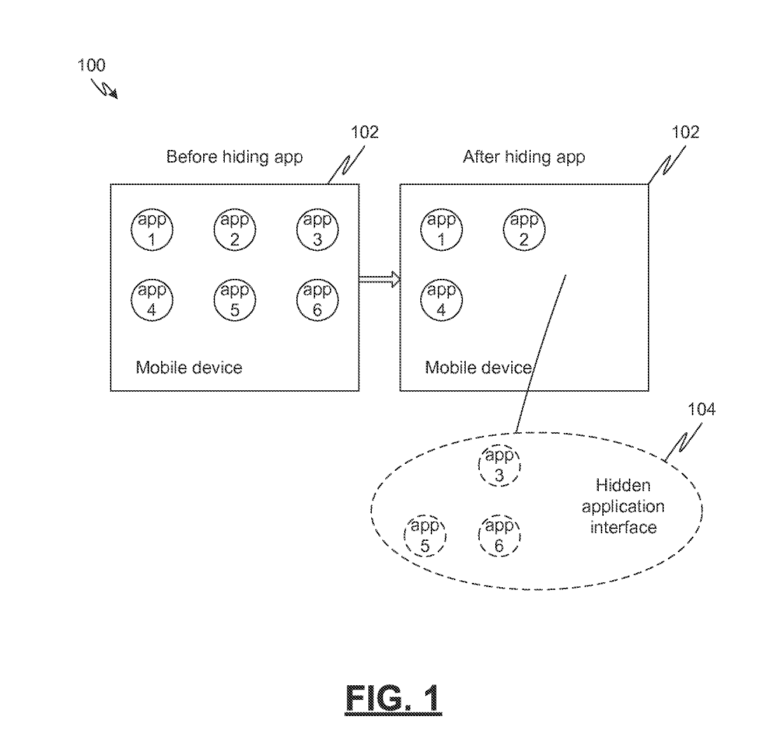

FIG. 1 depicts an example diagram showing certain applications being hidden from a user interface of a mobile device. As shown in FIG. 1, one or more applications are hidden from a user interface 102 of the mobile device 100, and can be displayed only on a hidden application interface 104 of the mobile device 100.

Specifically, the user interface 102 initially includes multiple applications. For example, icons for the applications, such as “app 1,” “app 2,” “app 3,” “app 4,” “app 5,” and “app 6,” are shown on the user interface 102. A user may choose to hide certain applications (e.g., “app 3,” “app 5,” and “app 6”) from the user interface 102. Eventually, the remaining applications, such as “app 1,” “app 2,” and “app 4,” are shown on the user interface 102, while the hidden applications (e.g. “app 3,” “app 5,” and “app 6”) are shown only on the hidden application interface 104 for user operations.

One or more application programming interfaces (APIs) are provided on the mobile device 100 for hiding applications. A triggering event may initiate a process of calling the APIs to display the hidden application interface 104. For example, a user entry of a numerical code (e.g., a series of numbers) may trigger the calling process of the APIs and the hidden application interface 104 may be displayed for application management. The user can perform various operations on the hidden application interface 104. For example, the user may select one or more applications to be included in a list of the hidden applications, add more applications to the list of the hidden applications, or remove certain applications from the list of the hidden applications so that the removed applications can be displayed on the user interface 102 (e.g., a home screen, a settings interface).

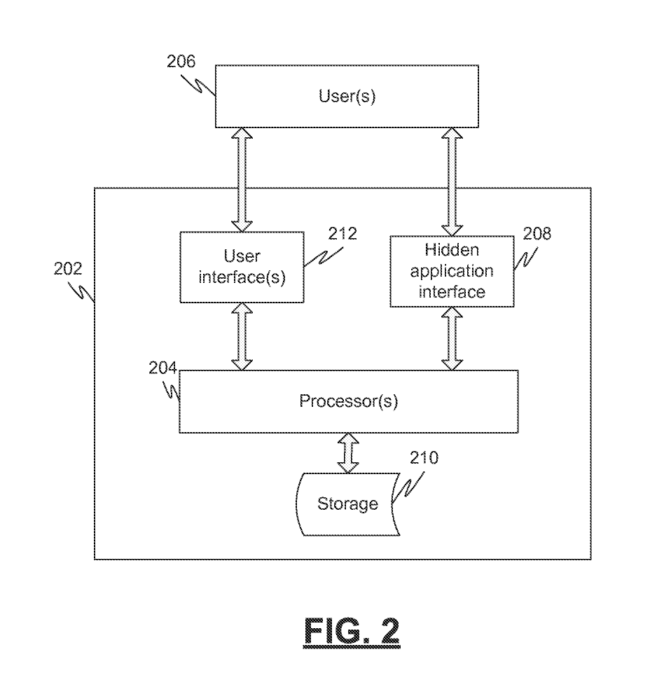

FIG. 2 depicts an example diagram showing a system for hiding certain applications on a mobile device. As shown in FIG. 2, a system 202 provides one or more APIs for hiding applications on a mobile device. One or more processors 204 call the APIs in response to a triggering event and hide one or more applications according to operations of a user 206 on a hidden application interface 208. The processors 204 extract information related to the hidden applications and store the extracted information in a storage 210 so that the information is not displayed on any user interface 212 other than the hidden application interface 208. For example, the triggering event corresponds to a user operation on the user interface 212. The system 202 is included in the mobile device.

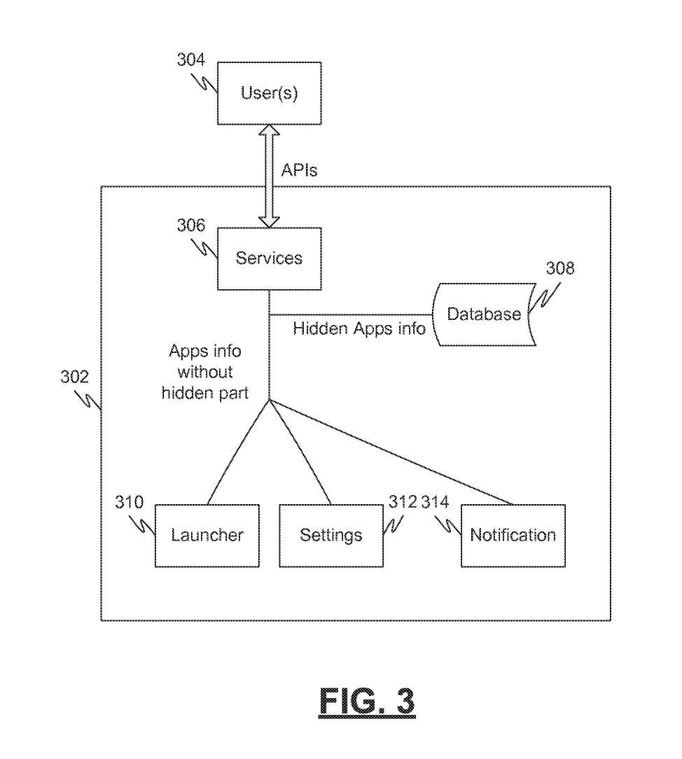

FIG. 3 depicts another example diagram showing a system for hiding certain applications on a mobile device. As shown in FIG. 3, a system 302 within a mobile device (e.g., a smart phone) is customized to provide a set of APIs to support hiding applications on the mobile device. One or more users 304 interact with the system 302 through the APIs, and user requests and a list of hidden applications re transmitted to the system 302.

One or more services 306 running on the background of the system 302 process the list of hidden applications (e.g., through co-operations of other parts of the mobile device) to hide information related to the applications that are included in the list of hidden applications. For example, the services 306 include a launcher, settings services, notification manager services, etc.

Information related to applications is initially stored in a regular application database (not shown in FIG. 3). The system 302 extracts the information related to the applications that are included in the list of hidden applications and stores the extracted information in a hidden application database 308. Irrelevant parts of the mobile device or third-party applications cannot access the hidden application database 308.

The information related to the hidden applications stored in the hidden application database 308 is prevented from being displayed on any user interface (other than a hidden application interface), such as a launcher interface 310, a settings interface 312, and a notification interface 314. For example, the launcher interface 310 does not include any icons that correspond to the hidden applications. The hidden applications can only be displayed on the hidden application interface.

In some embodiments, the users 304 may access the hidden application interface by entering a numerical code, e.g., a series of numbers. On the hidden application interface, the users 304 may perform various operations. For example, the users 304 may check whether a particular application is in the list of hidden applications, add more applications to the list of hidden applications, or remove some applications from the list of hidden applications so that such applications can be displayed on other user interfaces.

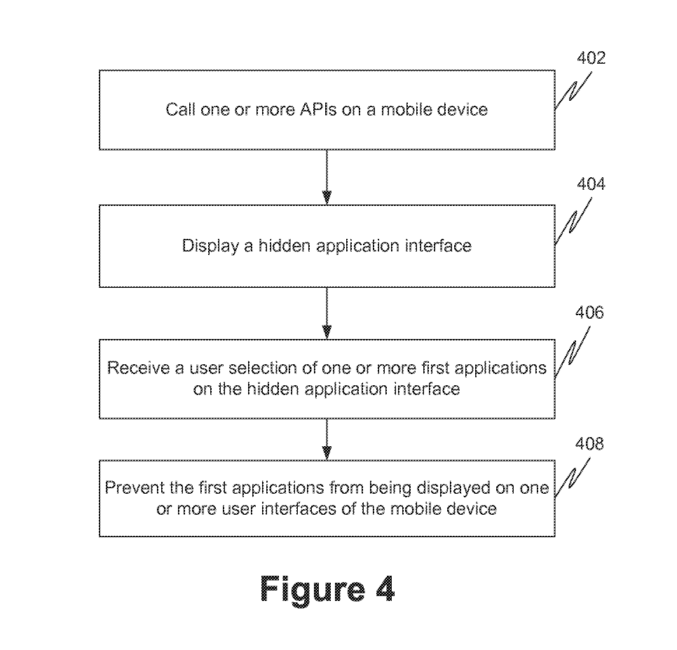

FIG. 4 depicts an example flow chart for application management on mobile devices. At 402, one or more application programming interfaces (APIs) on a mobile device are called in response to a triggering event. At 404, a hidden application interface is displayed. At 406, a user selection of one or more applications is received on the hidden application interface. At 408, the applications (e.g., icons of the applications) are prevented from being displayed on one or more user interfaces of the mobile device.

This written description uses examples to disclose the invention, include the best mode, and also to enable a person skilled in the art to make and use the invention. The patentable scope of the invention may include other examples that occur to those skilled in the art. Other implementations may also be used, however, such as firmware or appropriately designed hardware configured to carry out the methods and systems described herein. For example, the systems and methods described herein may be implemented in an independent processing engine, as a co-processor, or as a hardware accelerator. In yet another example, the systems and methods described herein may be provided on many different types of computer-readable media including computer storage mechanisms (e.g., CD-ROM, diskette, RAM, flash memory, computer's hard drive, etc.) that contain instructions (e.g., software) for use in execution by one or more processors to perform the methods' operations and implement the systems described herein.

What is claimed is:

1. A method for application management on mobile devices, the method comprising:
in response to a triggering event, calling one or more application programming interfaces (APIs) on a mobile device;
displaying a hidden application interface;
receiving a user selection of one or more first applications on the hidden application interface; and
preventing the first applications from being displayed on one or more user interfaces of the mobile device.

2. The method of claim 1, where the triggering event includes a specific user operation.

3. The method of claim 2, wherein the user operation includes a user entry of a numerical code.

4. The method of claim 1, wherein the first applications are displayed only on the hidden application interface.

5. The method of claim 1, wherein the user interfaces include one or more of: a launcher interface, a settings interface, and a notification interface.

6. The method of claim 1, wherein the triggering event is modified in response to user operations.

7. The method of claim 1, further comprising:
receiving a user selection of one or more second applications on the hidden application interface, the second applications being different from the first applications; and
preventing the second applications from being displayed on one or more user interfaces of the mobile device.

8. The method of claim 1, further comprising:
receiving a user selection of one or more second applications on the hidden application interface, the second applications being included in the first applications; and
displaying the second applications on the user interfaces.

9. The method of claim 1, further comprising:
extracting information related to the first applications; and
storing the extracted information related to the first applications in a hidden application database.

10. The method of claim 9, wherein:
one or more second applications are displayed on the user interfaces; and
information related to the second applications is stored in a regular application database different from the hidden application database.

11. A system for application management on mobile devices, the system comprising:
one or snore processors configured to:
in response to a triggering event, call one or more application programming interfaces (APIs) on a mobile device;
display a hidden application interface;
receive a user selection of one or more first applications on the hidden application interface; and
prevent the first applications from being displayed on one or more user interfaces of the mobile device; and
a computer-readable storage medium configured to store information related to the first applications.

12. The system of claim 11, where the triggering event includes a specific user operation.

13. The system of claim 12, wherein the user operation includes a user entry of a numerical code.

14. The system of claim 11, wherein the first applications are displayed only on the hidden application interface.

15. The system of claim 11, wherein the user interfaces include one or more of: a launcher interface, a settings interface, and a notification interface.

16. The system of claim 11, wherein the triggering event is modified in response to user operations.

17. The system of claim 11, wherein the processors are further configured to:
receive a user selection of one or more second applications on the hidden application interface, the second applications being different from the first applications; and
prevent the second applications from being displayed on one or more user interfaces of the mobile device.

18. The system of claim 11, wherein the processors are further configured to:
receive a user selection of one or more second applications on the hidden application interface, the second applications being included in the first applications; and
display the second applications on the user interfaces.

19. The system of claim 11, wherein:
the information related to the first applications is stored a hidden application database;
one or more second applications are displayed on the user interfaces; and
information related to the second applications is stored in a regular application database different from the hidden application database.

20. A non-transitory machine-readable storage medium comprising programming instructions for application management on mobile devices, the programming instructions configured to cause one or more data processors to execute operations comprising:
in response to a triggering event, calling one or more application programming interfaces (APIs) on a mobile device;
displaying a hidden application interface;
receiving a user selection of one or more first applications on the hidden application interface; and
preventing the first applications from being displayed on one or more user interfaces of the mobile device.
